(19) United States
(12) Patent Application Publication
(10) Pub. No.: US 2021/0220898 A1
(43) Pub. Date: Jul. 22, 2021

(54) MAGNESIUM ALLOY BUTTED TUBE DRAWING MECHANISM

(71) Applicant: JURNONG BAILEY MAGNESIUM ALLOY MATERIAL TECHNOLOGY CO., LTD., Jurong (CN)

(72) Inventors: Chunjiang MA, Jurong (CN); Jun YANG, Jurong (CN)

(21) Appl. No.: 17/055,849

(22) PCT Filed: May 16, 2019
(86) PCT No.: PCT/IB2019/054080

§ 371 Date: Nov. 16, 2020

(30) Foreign Application Priority Data
May 16, 2018 (CN) 201820726340.6

(51) Int. Cl. B21D 31/00; B21D 41/04; B21D 37/16; B21D 53/86; C22C 23/00

(52) U.S. Cl. CPC B21D 31/00; B21D 41/04; C22C 23/00; B21D 53/86; B21D 37/16

(57) ABSTRACT

A magnesium alloy thick and thin tube butting mechanism is disclosed in the utility model and includes a tube butting mold, a tube butting mandrel, and a hydraulic actuator. The tube butting mold has a mold heating component used for magnesium alloy tube to enter a tube wire drawing mold. A material is heated. The magnesium alloy thick and thin tube butting mechanism may further include a tube heating component configured to pre-heat the magnesium alloy tube before the magnesium alloy tube enters a tube mold.

### BACKGROUND

### Technical Field

The utility model relates to a thick and thin tube butting device, and particularly, to a magnesium alloy thick and thin tube butting mechanism.

### Related Art

Magnesium alloy has advantages such as light weight, high specific strength and specific modulus, good damping shock absorbing performance, and rich resources, and is easy to be recycled. Therefore, magnesium alloy is widely applied in transportation industries such as aerospace, automobile, and rail transit, and is also favored by sports equipment and bicycle industries. Some enterprises use magnesium alloy to design and manufacture bicycle frames and other structural components. However, as the most important safety structural component of a bicycle, a bicycle frame needs to withstand complicated impact fatigue during use, and heat affected zones in tubing welding of a magnesium alloy bicycle frame have difficulty in withstanding high-degree fatigue, consequently, fatigue fractures occur near the heat affected zones in welding. Therefore, as shown in FIG. 1, to weld a bicycle frame by using magnesium alloy tubing, a thick and thin tube of an unequal wall thickness that a wall thickness of tubing at a welding part is slightly large, and a wall thickness at a middle part of a tubing length is relatively small is needed, so as to enhance strength of the welding part and reduce rigidity of the middle part of the tubing at the same time, ensure that the frame is under uniform force, and reduce the rate of a fatigue fracture at the welding part of the frame.

To reduce the weight while satisfying the fatigue safety performance for a high-quality aluminum alloy frame, thick and thin tube butting processing is also needed to be performed on aluminum alloy tubing. Because of good plasticity of aluminum alloy at a room temperature, it is easy to deform a butted tube at a room temperature. However, magnesium alloy is in a close-packed hexagonal crystal structure, and has poor plasticity at a room temperature, therefore, it is impossible to deform a magnesium alloy thick and thin tube by using an aluminum alloy tube butting device and process. The magnesium alloy thick and thin tube cannot be prepared because the magnesium alloy is easy to deform and crack in a process of deforming the butted tube. Currently, there is no special magnesium alloy tube butting device.

### SUMMARY

An objective of the utility model: to resolve a problem that an existing conventional aluminum alloy tube butting device cannot be used in magnesium alloy tube butting processing, a magnesium alloy thick and thin tube butting mechanism is provided in the utility model.

Technical solutions: the magnesium alloy thick and thin tube butting mechanism described in the utility model includes a tube butting mold, a tube butting mandrel, and a hydraulic actuator, the tube butting mold and the tube butting mandrel being configured to form and mold the magnesium alloy tubing into a magnesium alloy thick and thin tube, and the hydraulic actuator being configured to push the magnesium alloy tubing and the tube butting mandrel to perform a reciprocating motion, to enter or exit the tube butting mold, where a mold heating component is disposed inside the tube butting mold and is configured to heat the magnesium alloy tubing entering the tube butting mold, so that the magnesium alloy tubing is in a heated state during forming and molding.

By setting the mold heating component, the tube butting mold may be heated to a certain tube butting temperature, so that the magnesium alloy tubing has good plasticity during tube butting, and deformation or cracking in the process of tube butting are prevented.

The mold heating component is preferably a resistive heater.

Preferably, the magnesium alloy thick and thin tube butting mechanism may further include a tubing heating component which is configured to rapidly pre-heat the magnesium alloy tubing before the magnesium alloy tubing enters the tube butting mold, to prevent the tube butting from being affected because of a too-slow heat-up speed of the magnesium alloy tubing entering the tube butting mold. An electromagnetic induction heating coil is preferably adopted by the tubing heating component and is connected to a high-frequency induction heating power supply. The high-frequency induction heating power supply provides an electromagnetic induction heating current for the electromagnetic induction heating coil.

Further, the magnesium alloy thick and thin tube butting mechanism according to the utility model further includes a baffle, the baffle being provided with a through-hole for the tube butting mandrel to exit. During a return process of the tube butting mandrel, the magnesium alloy tubing may be baffled by the baffle, and the tube butting mandrel exits at the same time, and the tube butting is completed.

In all components of the magnesium alloy thick and thin tube butting mechanism, the tube butting mold and the tubing heating component can be coaxially arranged.

During operation, the tube butting mold is heated to a magnesium alloy tube butting process temperature by using the mold heating component, and then, the hydraulic actuator pushes the tube butting mandrel to drive the magnesium alloy tubing to be preheated through the tubing heating component and enter the tube butting mold for tube butting.

Beneficial effects: compared with the prior art, the advantage of the utility model is that the magnesium alloy thick and thin tube butting mechanism according to the utility model adds the mold heating component in an existing aluminum alloy tube butting device, so that the magnesium alloy thick and thin tube is in a heated state during forming and molding, thereby effectively improving plasticity of the magnesium alloy, and resolving a problem that the magnesium alloy thick and thin tube deforms and cracks during the tube butting and cannot be formed and molded. By adding the tubing heating component, the magnesium alloy tubing may be rapidly pre-heated before tube butting, so that the temperature of the magnesium alloy tubing entering the tube butting mold can rise rapidly and stably, and the tube butting quality and efficiency are improved.

### BRIEF DESCRIPTION OF THE DRAWINGS

FIG. 1 is a schematic structural diagram of a magnesium alloy thick and thin tube;

FIG. 2 is a schematic structural diagram of a magnesium alloy thick and thin tube butting mechanism according to the utility model;

FIG. 3 is a diagram of a changing process of an end socket structure when performing head retracting on a magnesium alloy tubing in a process of forming and molding a double-butted tube;

FIG. 4 is a diagram of a tube butting process of a magnesium alloy tubing when using a first mold mandrel for tube butting in a process of forming and molding a double-butted tube; and

FIG. 5 is a diagram of a tube butting process of a magnesium alloy tubing when using a second mold mandrel for tube butting in a process of forming and molding a double-butted tube.

### DETAILED DESCRIPTION

The technical solutions of the utility model are further described with reference to the accompany drawings.

As shown in FIG. 2, a magnesium alloy thick and thin tube butting mechanism according to the utility model is provided, including a base 8, a tube butting mold 1, a tube butting mandrel, and a hydraulic actuator 6.

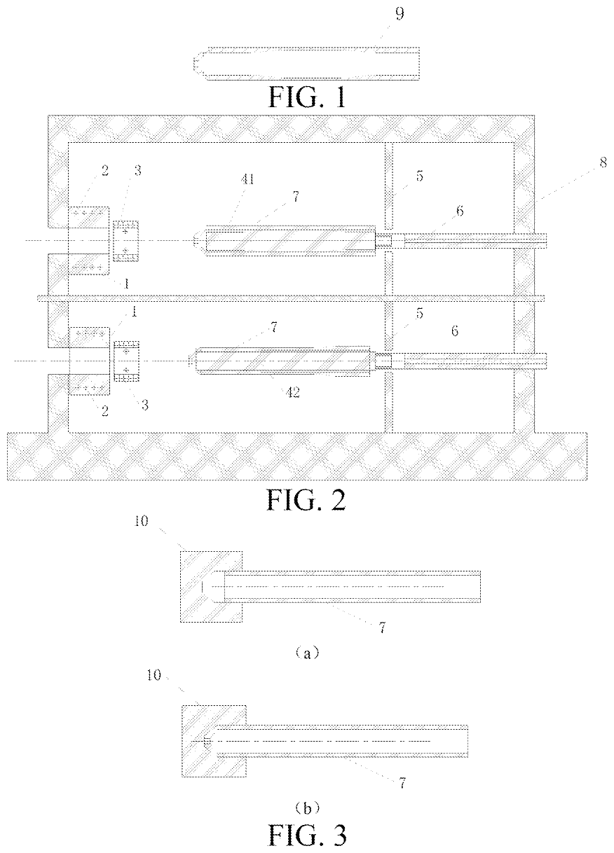

The tube butting mold 1 fits the tube butting mandrel, and the tube butting mandrel is placed into magnesium alloy tubing 7. The magnesium alloy tubing 7 of an equal wall thickness may be formed and molded into a magnesium alloy thick and thin tube by using an outer size of the tube butting mandrel and a size of an inner bore of the tube butting mold 1. The tube butting mold 1 is fixed on the base 8, a mold heating component 2, for example, a resistive heater, is disposed inside the tube butting mold 1. The tube butting mold 1 may be heated to a certain tube butting process temperature according to process requirements. When the magnesium alloy tubing 7 enters the tube butting mold 1, tube butting may be completed in a heated state, and plasticity of the magnesium alloy may be effectively improved, so that a problem that the magnesium alloy thick and thin tube deforms and cracks during the tube butting and cannot be formed and molded may be resolved. The size and quantity of the adopted tube butting mandrel are different as structures of the magnesium alloy thick and thin tubes are different. For example, as shown in FIG. 1, for a magnesium alloy thick and thin tube 9 of which two sides are thick and a middle part is thin, the tube butting process needs two tube butting mandrels of different sizes, including a first mold mandrel 41 and a second mold mandrel 42.

The hydraulic actuator 6 is fixed on the base 8 and may be a hydraulic cylinder. The hydraulic actuator 6 is connected to a hydraulic control system, and the hydraulic control system provides power for the hydraulic actuator 6, so that the hydraulic actuator 6 is capable of pushing the tube butting mandrel to drive the magnesium alloy tubing 7 to perform a reciprocating motion, to enter or exit the tube butting mold 1.

The magnesium alloy thick and thin tube butting mechanism according to the utility model may further include a tubing heating component 3. The tubing heating component 3 is located at a front end of the tube butting mold 1, and may rapidly pre-heat the magnesium alloy tubing 7 before the magnesium alloy tubing 7 enters the tube butting mold 1, and the tube butting may be prevented from being affected because of a too-slow heat-up speed of the magnesium alloy tubing entering the tube butting mold by using rapid pre-heating. The tubing heating component 3 may be an electromagnetic induction heating coil, which is connected to a high-frequency induction heating power supply. The high-frequency induction heating power supply provides a heating current for the electromagnetic induction heating coil.

A baffle 5 is further fixed on the base 8 of the magnesium alloy thick and thin tube butting mechanism. The baffle 5 is provided with a through-hole. A bore diameter of the through-hole is slightly greater than an outer diameter of the tube butting mandrel and less than an outer diameter of the magnesium alloy thick and thin tube. When the tube butting mandrel drives the magnesium alloy tubing to return, the tube butting mandrel may exit, and the magnesium alloy tubing is baffled at the same time, so that the tube butting mandrel and the magnesium alloy tubing are separated, and the tube butting is completed.

During operation, the tube butting mold 1 is heated to a certain tube butting process temperature by using the mold heating component 2, and then, the hydraulic actuator 6 pushes the tube butting mandrel to drive the magnesium alloy tubing 7 to first be rapidly pre-heated through the tubing heating component 3 and then enter the tube butting mold, and the tube butting process is completed.

An operation process of the magnesium alloy thick and thin tube according to the utility model is described by using an example in which the magnesium alloy thick and thin tube 9 in FIG. 1 is formed and molded. In this example, the magnesium alloy thick and thin tube 9 is a double-butted tube, and tube butting needs to be completed by using two tube butting mandrels of different sizes, which are the first mold mandrel 41 and the second mold mandrel 42 respectively. At the same time, in this example, a resistive heater is adopted by the mold heating component 2, an induction heating coil is adopted by the tubing heating component 3, and a hydraulic cylinder is adopted by the hydraulic actuator 6.

The operation process of the tube butting by using a magnesium alloy thick and thin tube butting mechanism according to the utility model is as follows:

(1) head retracting: as shown in FIG. 3 (a), the magnesium alloy tubing 7 is inserted into a conoid inner bore mold 10, and the temperature of the mold is between 200° C. and 400° C., and as shown in FIG. 3 (b), an end socket of the magnesium alloy tubing 7 is shaped in a cone;

(2) tube butting:

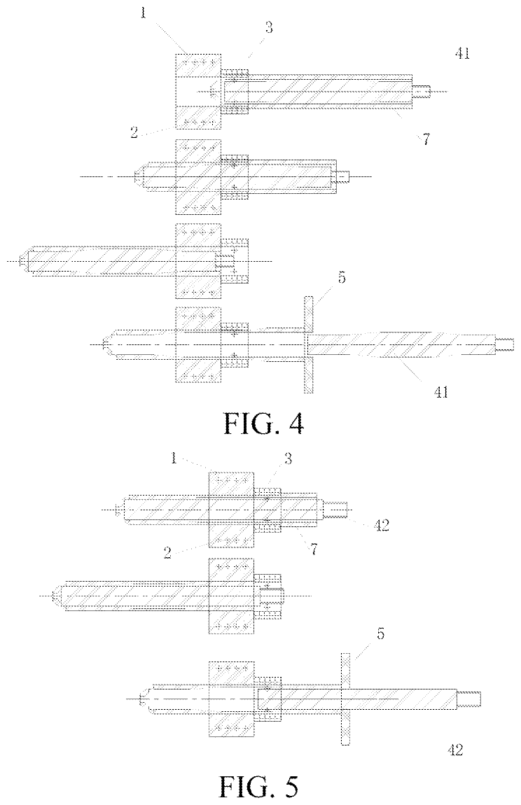

A. A first mold: as shown in FIG. 4, the magnesium alloy tubing 7 after head retracting is inserted into the first mold mandrel 41 of which an outer size is a size of the inner bore of the thick and thin tube. The first mold mandrel 41 is pressed against the head retracting part of the magnesium alloy tubing 7, and the hydraulic cylinder is started to push the magnesium alloy tubing 7 to pass through the induction heating coil and the inner bore of the tube butting mold 1. The outer size of the first mold mandrel 41 and the size of the inner bore of the tube butting mold 1 form the magnesium alloy thick and thin tube together. During the tube butting, the tube butting mold 1 is heated by the resistive heater to maintain a temperature between 200° C. and 400° C. to ensure that cracking does not occur to the magnesium alloy butted tube. During a return process of the first mold mandrel 41, the magnesium alloy tubing 7 is baffled by the baffle 5, and in this case, the first mold mandrel 41 exits, and the first mold of the tube butting is completed;

B. A second mold: because a diameter of a middle section of the first mold mandrel 41 is greater than a size of an inner bore at a tail end of the magnesium alloy thick and thin tube, during the process in which the first mold mandrel 41 exits, a diameter of the magnesium alloy tube at the tail end is enlarged by the first mold mandrel 41. As shown in FIG. 5, secondary tube butting is performed on the magnesium alloy tubing 7 by using the second mold mandrel 42 having a size slightly less than the size of the inner bore of the magnesium alloy and a same outer mold. A raised part at the tail end is flattened to obtain a magnesium alloy thick and thin tube having a consistent outer diameter and different inner diameters.

What is claimed is:

1. A magnesium alloy thick and thin tube butting mechanism, comprising a tube butting mold, a tube butting mandrel, and a hydraulic actuator, wherein a mold heating component is disposed inside the tube butting mold and is configured to heat magnesium alloy tubing entering the tube butting mold.

2. The magnesium alloy thick and thin tube butting mechanism according to claim 1, wherein the mold heating component is a resistive heater.

3. The magnesium alloy thick and thin tube butting mechanism according to claim 1, further comprising a tubing heating component, the tubing heating component being configured to rapidly heat the magnesium alloy tubing before the magnesium alloy tubing enters the tube butting mold.

4. The magnesium alloy thick and thin tube butting mechanism according to claim 3, wherein the tubing heating component is an electromagnetic induction heating coil, and the electromagnetic induction heating coil is connected to a high-frequency induction heating power supply.

5. The magnesium alloy thick and thin tube butting mechanism according to claim 3, wherein the tubing heating component and the tube butting mold are coaxially arranged.

6. The magnesium alloy thick and thin tube butting mechanism according to claim 1, further comprising a baffle, the baffle being provided with a through-hole for the tube butting mandrel to exit.
